(19) United States
(12) Patent Application Publication
(10) Pub. No.: US 2006/0074137 A1
(43) Pub. Date: Apr. 6, 2006

(54) Process for preparing expandable polystyrene resin and expandable polystyrene resin composition

(76) Inventors: Bong-keun Ahn, Daejeon (KR); Sung-ho Baek, Goheung-gun (KR); Keun-hoon Yoo, Yeosu-si (KR); Jong-un Lee, Yeosu-si (KR); Jong-cheol Won, Uijeongbu-si (KR)

Correspondence Address: CANTOR COLBURN, LLP, 55 GRIFFIN ROAD SOUTH, BLOOMFIELD, CT, 06002, US

(21) Appl. No.: 11/098,965

(22) Filed: Apr. 5, 2005

(30) Foreign Application Priority Data
Oct. 5, 2004 (KR) 10-2004-0079113

(51) Int. Cl. C08G 18/48

(52) U.S. Cl. 521/131

(57) ABSTRACT

Provided are a process for preparing an expandable polystyrene (EPS) resin using polyoxyethylene sorbitan monolaurate and a polyethylene wax synthesized from methylene oxide, and an EPS resin composition including a Sasol-wax which is a polyethylene wax synthesized from methylene oxide. The EPS resin is excellent in expandability and strength, and can be processed into a desirable foamed product even when it is subjected to short-term maturing after pre-expansion. Addition of divinylbenzene as a crosslinking agent at an initial stage of polymerization and addition of a mixture of butane, pentane, and cyclohexane as a blowing agent permit the EPS resin to be expanded at a high expansion ratio of 93 times or more. Further, addition of a polyethylene wax synthesized from methylene oxide at an initial stage of polymerization and addition of polyoxyethylene sorbitan monolaurate in the course of the polymerization, in particular when a polymerization ratio reaches 70-90%, can impart good strength to the EPS resin.

### TECHNICAL FIELD

The present invention relates to expandable polystyrene (EPS) particles which are improved in expandability and strength, compared to common EPS particles, a process for preparing the same, and a foamed product produced using the EPS particles.

According to the process of the present invention, the EPS particles can be prepared using divinylbenzene as a crosslinking agent and a mixture of butane, pentane, and cyclohexane as a blowing agent. Therefore, the EPS particles can be expanded at a high expansion ratio of 93 times or more and can be processed into a desirable foamed product even when they are subjected to short-term maturing after pre-expansion.

The foamed product produced using the EPS particles with good expandability and strength according to the present invention exhibits a more excellent impact cushioning effect, as compared to common foamed products. Therefore, a smaller amount of the foamed product can be used as a package or a buffer.

More particularly, the present invention relates to a process for preparing an EPS resin using polyoxyethylene sorbitan monolaurate and a polyethylene wax synthesized from methylene oxide, and an EPS resin composition including a Sasol-wax which is a polyethylene wax synthesized from methylene oxide.

In the process for preparing the EPS resin according to the present invention, addition of divinylbenzene as a crosslinking agent at an initial stage of polymerization and a mixture of butane, pentane, and cyclohexane as a blowing agent permits the EPS resin to be expanded at a high expansion ratio of 93 times or more. Furthermore, addition of a polyethylene wax synthesized from methylene oxide at an initial stage of polymerization and addition of polyoxyethylene sorbitan monolaurate during the polymerization, in particular, when a polymerization ratio reaches 70-90%, can impart good strength to the EPS resin. In addition, the EPS resin prepared according to the process of the present invention can be processed into a desirable foamed product even when it is subjected to short-term maturing after pre-expansion.

### BACKGROUND ART

In production of highly expandable styrene resins, aromatic hydrocarbons such as toluene and ethylbenzene have been generally used (see Japanese Patent Laid-Open Publication No. Hei. 11-255947). However, the aromatic hydrocarbons may adversely affect human bodies.

Japanese Patent Laid-Open Publication No. Hei. 9-111035 discloses a process for preparing an expandable styrene polymer with an excellent strength using an electrolyte such as NaCl. However, an unstable particle phase may be formed.

In addition, Japanese Patent Laid-Open Publication No. Hei. 11-246700 discloses a process for preparing an expandable styrene resin with an improved strength using benzoxazolyl thiophene. However, a flexural strength may be lowered.

### DISCLOSURE OF INVENTION

The present invention provides an expandable polystyrene (EPS) resin that is excellent in expandability and strength and can be processed into a desirable foamed product even when it is subjected to short-term maturing after pre-expansion, a process for preparing the same, and a foamed product produced using the EPS resin.

An EPS resin according to the present invention is prepared using polyoxyethylene sorbitan monolaurate and a polyethylene wax synthesized from methylene oxide.

The present invention also provides an EPS resin composition including a Sasol-wax which is a polyethylene wax synthesized from methylene oxide.

In more detail, the present invention provides an EPS resin composition including divinylbenzene as a crosslinking agent, and polyoxyethylene sorbitan monolaurate and a polyethylene wax synthesized from methylene oxide as strength enhancers.

Preferably, the present invention provides a process for preparing an EPS resin with good expandability and strength by suspension polymerization using the monomers, an initiator, a dispersing agent, a dispersion aid, a blowing agent, and water, the process including adding divinylbenzene as a crosslinking agent and a polyethylene wax synthesized from methylene oxide as a nucleating agent at an initial stage of polymerization and adding polyoxyethylene sorbitan monolaurate capable of preventing a change in size of foam cells when a polymerization ratio reaches 70-90%.

The polyethylene wax synthesized from methylene oxide is in a powder phase, unlike a polyethylene wax synthesized from ethylene. The polyethylene wax synthesized from methylene oxide and the polyethylene wax synthesized from ethylene are different in degree of polymerization and molecular weight. Preferably, the polyethylene wax synthesized from methylene oxide is used in an amount of 0.05 to 0.2 parts by weight, based on 100 parts by weight of the monomers.

If the content of the polyethylene wax synthesized from methylene oxide is less than 0.05 parts by weight, the function as a nucleating agent may be insufficient. On the other hand, if it exceeds 0.2 parts by weight, the size of foam cells may be decreased.

The polyoxyethylene sorbitan monolaurate has a more complex structure, relative to the polyethylene wax synthesized from methylene oxide and the polyethylene wax synthesized from ethylene, and thus, is useful in adjusting the size of foam cells. Furthermore, the polyoxyethylene sorbitan monolaurate facilitates vaporization of residues such as a blowing agent or moisture after pre-expansion, thereby decreasing a maturing time after the pre-expansion.

Polyoxyethylene sorbitan monostearate, polyoxyethylene sorbitan monooleate, a fatty acid ester of glycerine acetic acid, etc. may be used as a substitute for the polyoxyethylene sorbitan monolaurate. An EPS resin composition of the present invention may include one or more selected from polyoxyethylene sorbitan monolaurate, polyoxyethylene sorbitan monostearate, polyoxyethylene sorbitan monooleate, and a fatty acid ester of glycerine acetic acid.

Preferably, the polyoxyethylene sorbitan monolaurate or its substitute is used in an amount of 0.05 to 0.15 parts by weight, based on 100 parts by weight of the monomers. If the content of the polyoxyethylene sorbitan monolaurate or its substitute is less than 0.05 parts by weight, an addition effect may be insufficient. On the other hand, if it exceeds 0.15 parts by weight, bead agglomeration may occur. Preferably, the polyoxyethylene sorbitan monolaurate or its substitute is added when a polymerization ratio reaches 70-90%. If the addition of the polyoxyethylene sorbitan monolaurate or its substitute is performed before a polymerization ratio reaches 70%, an addition effect may be insufficient. On the other hand, if the addition of the polyoxyethylene sorbitan monolaurate or its substitute is performed after a polymerization ratio reaches 90%, polymerization stability may be lowered.

An EPS resin that can be prepared according to the present invention is not particularly limited but may be polystyrene; a homopolymer of alkylstyrene such as alpha-methylstyrene, para-methylstyrene, and tert-butylstyrene; a copolymer of styrene and alkylstyrene; a homopolymer of halogenated styrene such as chlorostyrene and bromostyrene; a copolymer of styrene and halogenated styrene; a copolymer of styrene and (meth)acrylic acid; a copolymer of styrene and acrylic ester (e.g.: methyl acrylate, ethyl acrylate, butyl acrylate) or methacrylic ester; a copolymer of styrene and acrylonitrile or methacrylonitrile; a combination of polyolefin and one of the above-illustrated styrene polymers, etc.

A styrene homopolymer, i.e., polystyrene which is effective in reduction in cooling time during a molding process is particularly preferable.

Particularly, use of polystyrene with weight average molecular weight of 150,000-400,000 can remarkably enhance the strength of a foamed product. Polystyrene with weight average molecular weight of 250,000-350,000 is particularly preferable because it is excellent in prevention of shrinkage after high-ratio expansion, and in balance of strength and fusing property.

The above-described EPS resin may be prepared by suspension polymerization of the monomers in an aqueous medium.

A polymerization initiator may be used in the suspension polymerization. Non-limiting examples of the polymerization initiator include benzoyl peroxide, t-butyl peroxy benzoate, di-cumyl peroxide, tertiary amyl peroxy 2-ethyl hexyl carbonate, lauryl peroxide, t-butyl peroxy isopropyl carbonate, cumene hydroxy peroxide, and a combination thereof. To accelerate polymerization, it is preferable to use two or more types of polymerization initiators which are different in the decomposition temperature. Preferably, the polymerization initiator is used in an amount of 0.01 to 1 part by weight, based on 100 parts by weight of the monomers.

A dispersing agent may be used in the suspension polymerization. Non-limiting examples of the dispersing agent include organic dispersing agents such as polyvinylalcohol, methylcellulose, and polyvinylpyrrolidone, and sparsely soluble inorganic salts such as tricalcium phosphate and magnesium pyrrophosphate. Preferably, the dispersing agent is used in an amount of 0.01 to 1 part by weight, based on 100 parts by weight of the monomers.

A dispersion aid may also be used in the suspension polymerization to impart stability to a dispersion phase. Non-limiting examples of the dispersion aid include hydroxy epitite, ammonium persulfate, potassium persulfate, magnesium sulfate hydroxide, calcium hydroxide, sodium dodecylbenzenesulfonate, alkyldiphenylether disulfate, and a combination thereof. Preferably, the dispersion aid is used in an amount of 0.0001 to 0.01 parts by weight, based on 100 parts by weight of the monomers.

A crosslinking agent such as divinylbenzene and alpha-methylstyrene dimer may also be used to obtain an EPS resin with good expandability. The crosslinking agent also serves to prevent shrinkage that may be caused after high-ratio expansion. Preferably, the crosslinking agent is used in an amount of 0.005 to 0.05 parts by weight, based on 100 parts by weight of the monomers.

A flame retardant may also be used in the suspension polymerization. The flame retardant may be a halogen-type flame retardant such as hexabromododecane, tetrabromobutane, hexabromocyclohexane, tetrabromo bisphenol A, tetrabromo bisphenol F, tetrabromo bisphenol A diglycidyl ether, or the like. Preferably, the flame retardant is used in an amount of 0.1 to 3 parts by weight, based on 100 parts by weight of the monomers.

Non-limiting examples of a blowing agent that can be used herein include hydrocarbon compounds with 3-6 carbon atoms, including butanes such as n-butane, isobutene, and cyclobutane; pentanes such as n-pentane, isopentane, cyclopentane, and neopentane; and cyclohexane. To accelerate a maturing process and obtain an EPS resin with good expandability, it is preferable to use two or more types of blowing agents which are different in boiling point. When pentane is used as a blowing agent, it is preferable to use a mixture of n-pentane and isopentane in a weight ratio of 60:40 to 70:30. If the ratio of n-pentane exceeds 70 wt %, shrinkage after expansion may occur. On the other hand, if it is less than 60 wt %, high-ratio expansion may be difficult and a maturing process may be retarded.

Preferably, the blowing agent is used in an amount of 3 to 10 parts by weight, based on 100 parts by weight of the monomers.

A thermal stabilizer may also be used to prevent oxidation. The thermal stabilizer may be dibutyltin dimaleate or one or more selected from the group consisting of commonly used antioxidants. Preferably, the thermal stabilizer is used in an amount of 0.001 to 0.005 parts by weight.

As described above, the present invention provides a process for preparing an EPS resin using polyoxyethylene sorbitan monolaurate, a polyethylene wax synthesized from methylene oxide, the monomers, a polymerization initiator, a dispersing agent, a dispersion aid, a blowing agent, water, etc. A process for preparing an EPS resin according to the present invention will now be specifically described but the present invention is not limited thereto.

At an initial stage of polymerization, 100 parts by weight of the monomers, 1 to 5 parts by weight of polystyrene recycle beads, 0.1 to 3 parts by weight of a flame retardant, 0.01 to 1 part by weight of a polymerization initiator, 0.005 to 0.05 parts by weight of a crosslinking agent, and 0.05 to 0.2 parts by weight of a polyethylene wax synthesized from methylene oxide as a nucleating agent are injected into a reactor equipped with an agitator and stirred for 30 minutes to 1 hour.

Then, 80 to 110 parts by weight of ionized water (based on 100 parts by weight of the monomers) and 0.01 to 0.5 parts by weight of a dispersing agent (based on 100 parts by weight of the monomers) are added thereto and stirred for 30 minutes to 1 hour. Then, the reaction temperature is elevated to 85 to 95° C. At 30 minutes to 1 hour after the elevation of the reaction temperature, 0.0001 to 0.01 parts by weight of a dispersion aid is added, based on 100 parts by weight of the monomers, and the reaction solution is maintained at 85 to 95° C. for 3 to 4 hours. Then, 0.1 to 0.5 parts by weight of the dispersing agent is added and the reaction solution is maintained at 85 to 95° C. for 4 to 5 hours.

Then, the reaction solution is elevated to a temperature of 95 to 110° C. for 30 minutes to 1 hour and then maintained at the same temperature for 30 minutes to 1 hour. In the course of the temperature elevation of the reaction solution, 0.05 to 0.15 parts by weight of polyoxyethylene sorbitan monolaurate or its substitute, 0.0001 to 0.01 parts by weight of a dispersion aid, and 0.001 to 0.005 parts by weight of a thermal stabilizer are added, based on 100 parts by weight of the monomers.

When the temperature elevation of the reaction solution to 95 to 110° C. is completed, 3 to 10 parts by weight of a blowing agent is added, based on 100 parts by weight of the monomers, and the reaction solution is maintained at 95 to 105° C. for 30 minutes to 1 hour. Then, the reaction solution is elevated to a temperature to 120 to 130° C. for 30 minutes to 1 hour, maintained at the same temperature for 1 to 3 hours, and then cooled to room temperature for 1 to 3 hours.

Bead slurry obtained after the cooling is treated with hydrochloric acid to remove the dispersing agent, dehydrated and dried to obtain an EPS resin.

At this time, the polyethylene wax (e.g., Sasol-wax) synthesized from methylene oxide and polyoxyethylene sorbitan monolaurate used as strength enhancers are present in a dispersion phase in finally obtained EPS resin.

The EPS resin thus obtained may be coated with a coating agent for the purposes of reduction in cycle time, adjustment of water content, enhancement in releasing property, antistatic effect, and prevention of lump formation. Various types of coating agents may be used according to the purposes. Generally, the coating agent may be one or more selected from glycerol monostearate, glycerol tristearate, zinc stearate, and hydrogenated castor oil (HCO). The content of the coating layer is not particularly limited but may be in the range of 2,000 to 10,000 ppm, based on 100 parts by weight of the EPS resin, to obtain desired purposes.

Subsequently, the EPS resin is expanded at an expansion ratio of 20 to 100 times in an expander using a 85-110° C. steam to prepare pre-foamed particles (pre-expansion process) and then air is allowed to be infiltrated into the pre-foamed particles to remove moisture from the particles (maturing process). Then, the matured pre-foamed particles are filled in a closed die with small holes or slits and heated with steam to thereby produce a foamed product by fusion of the particles.

Hereinafter, the present invention will be described more specifically by Examples. However, the following Examples are provided only for illustrations and thus the present invention is not limited to or by them.

### MODES FOR CARRYING OUT THE INVENTION

Monomers used in polymerization according to the present invention occupy 40-60 wt % of a resin composition.

### Example 1

250 kg of styrene monomers, 6.6 kg of polystyrene recycle beads (Mw: 250,000 to 350,000), 825 g of benzoyl peroxide, 125 g of t-butyl perbenzoate, and 750 g of di-cumyl peroxide as initiators, 61 g of divinylbenzene as a crosslinking agent, 250 g of Sasol-wax (manufactured by Sasol, SP30, Mw: 820, degree of polymerization: 58), and 1.5 kg of hexabromocyclododecane were injected into a 700 L reactor equipped with an agitator and stirred for 30 minutes to prepare a dispersion solution. Then, 400 g of tricalcium phosphate as a dispersing agent and 250 kg of ionized water were added and stirred for 30 minutes.

The reactor was sealed, and the reaction solution was elevated to a temperature of 90° C. for one hour and maintained at the same temperature for 30 minutes. Then, 6.1 g of a 10% aqueous solution of potassium persulfate as a dispersion aid was added to the reaction solution. At 3 hours after the addition of the dispersion aid, 400 g of tricalcium phosphate as a dispersing agent was added, and the reaction solution was maintained at 90° C. for 4 hours and then elevated to a temperature of 100° C. for 50 minutes. In the course of the elevation of the reaction temperature, 200 g of polyoxyethylene sorbitan monolaurate (Monopol Twl-1030, Dongnam Chemical Co. Ltd., Korea), 0.61 g of a 10% aqueous solution of alkyldiphenylether disulfate as a dispersion aid, and 6.1 g of dibutyltin dimaleate as a thermal stabilizer were added. When the elevation of the reaction temperature to 100° C. was completed, a mixture of 5 kg of butane, 1.25 g of cyclohexane, and 13.75 kg of pentane (a 2:3 mixture of isopentane and n-pentane) as a blowing agent was added. The reaction solution was maintained at 100° C. for 40 minutes, elevated to a temperature of 125° C. for 50 minutes and maintained at the same temperature for 1.5 hours, and then cooled to room temperature for 2 hours.

After the polymerization terminated, the resultant solution was treated with a HCl solution to remove the dispersing agent, dehydrated and dried, to obtain EPS resin products. The EPS resin products were coated with 3,500 ppm of a coating agent, based on 100 parts by weight of the EPS resin products. At this time, a mixture of glycerol monostearate, glycerol tristearate, zinc stearate, and hydrogenated castor oil (HCO) in a composition ratio of 3:3:1:3 was used as the coating agent.

The EPS resin products thus obtained were expanded at an expansion ratio of 93 times in an expander, maintained at room temperature for 4 hours, and then processed into final foamed products using a vacuum shape molding machine (PKB-306VS, Daekong Machinery Industrial Co., Ltd., Korea). The foamed products were cut into sample pieces of 60 mm×45 mm×5 mm in size and then the compression strengths of the sample pieces were measured.

### Example 2

Foamed products were produced in the same manner as in Example 1 except that a mixture of 5 kg of butane, 1.25 kg of cyclohexane, and 13.75 kg of pentane (a mixture of isopentane and n-pentane (1:4, weight ratio)) was used as a blowing agent.

### Comparative Example 1

Foamed products were produced in the same manner as in Example 1 except that divinylbenzene as a crosslinking agent was not added.

### Comparative Example 2

Foamed products were produced in the same manner as in Example 1 except that 20 kg of pentane was used as a blowing agent.

### Comparative Example 3

Foamed products were produced in the same manner as in Example 1 except that 1,050 g of benzoyl peroxide was used as an initiator.

### Comparative Example 4

Foamed products were produced in the same manner as in Example 1 except that polyoxyethylene sorbitan monolaurate was not added.

### Comparative Example 5

Foamed products were produced in the same manner as in Example 1 except that a Poly-wax (Baker Petrolite Polywax-1000, degree of polymerization: 36) was used instead of a Sasol-wax, and polyoxyethylene sorbitan monolaurate was not used. Here, the Poly-wax was a polyethylene wax with an average molecular weight of 1,000 synthesized by ethylene copolymerization.

### Comparative Example 6

Foamed products were produced in the same manner as in Example 1 except that a Poly-wax (Baker Petrolite Polywax-1000, degree of polymerization: 36) was used instead of a Sasol-wax.

Cell morphology, appearance, flexural strength, compression strength, expandability for high-ratio expansion, and moldability with maturing time for the foamed products produced in Examples 1-2 and Comparative Examples 1-6 were evaluated according to JIS A9511 and the results are presented in Table 1 below.

TABLE 1

| | | Expandability | Moldability | | | Flexural | Compression |
|---|---|---|---|---|---|---|---|
| | | for high-ratio | with maturing | Cell | | strength | strength |
| Sample | Mw | expansion | time | morphology | Appearance | (kgf/cm) | (kgf/cm) |
| Example 1 | 310,000 | ⊚ | ⊚ | Uniform | Good | 3.30 | 2.40 |
| Example 2 | 310,000 | ◯ | ⊚ | Uniform | Good | 3.28 | 2.38 |
| Comp. 1 | 260,000 | X | X | Non-uniform | Poor | 2.95 | 2.10 |
| Comp. 2 | 310,000 | ◯ | X | Non-uniform | Poor | 3.26 | 2.35 |
| Comp. 3 | 290,000 | X | ◯ | Uniform | Good | 3.12 | 2.10 |
| Comp. 4 | 305,000 | ◯ | ◯ | Non-uniform | Good | 2.89 | 1.56 |
| Comp. 5 | 305,000 | ◯ | ◯ | Non-uniform | Good | 2.57 | 1.34 |
| Comp. 6 | 305,000 | ◯ | ◯ | Non-uniform | Good | 2.66 | 1.45 |

Mw: molecular weight,
Comp: Comparative Example

Expandability for High-Ratio Expansion

Expandability for high-ratio expansion was evaluated by measuring the shrinkage of foam cells at 4 hours after expansion at an expansion ratio of 93 times.
⊚: shrinkage of less than 2%
◯: shrinkage of 2 to 5%
×: shrinkage of more than 5%

Moldability with Maturing Time:

Moldability with maturing time was evaluated by reduction in cycle time when maturing was performed for 4 hours.
⊚: water cooling for 15 seconds, vacuum molding for 70-80 seconds or less
◯: water cooling for 15 seconds, vacuum molding for 80-90 seconds
×: water cooling for 15 seconds, vacuum molding for 100 seconds or more

According to a process of the present invention, an EPS resin is prepared by adding divinylbenzene as a crosslinking agent at an initial stage of polymerization and using a mixture of butane, pentane, and cyclohexane as a blowing agent. Therefore, the EPS resin can be expanded at a high expansion ratio of 93 times or more. Furthermore, addition of polyethylene wax synthesized from methylene oxide at an initial stage of polymerization and addition of polyoxyethylene sorbitan monolaurate in the course of the polymerization, in particular when a polymerization ratio reaches 70-90%, can impart good strength to the EPS resin. In addition, the EPS resin has good moldability even when it is subjected to short-term maturing after pre-expansion.

### INDUSTRIAL APPLICABILITY

Foamed products produced using EPS resins are resource-saving products composed of air and a resin (98:2, volume ratio) and are used as packages for electronic products, boxes for agricultural and marine products, buoys for cultivation, heat insulating materials for housing, etc. because they are excellent in buffer action, water resistance, keeping warm, and heat insulating property.

In particular, a foamed product produced using an EPS resin with good expandability and strength according to the present invention exhibits a more excellent impact cushioning effect, as compared to common foamed products. Therefore, a smaller amount of the foamed product can be used as a package or a buffer.

That is, an EPS resin according to the present invention has good expandability and thus can be used in a decreased amount for molding, and has good strength and thus can serve as a good buffer for a highly loaded product.

The present invention provides a process for preparing an EPS resin using divinylbenzene as a crosslinking agent and a mixture of butane, pentane (a mixture of n-pentane and isopentane), and cyclohexane as a blowing agent. Therefore, the EPS resin can be expanded at a high expansion ratio of 93 times or more, has good strength, and can be processed into a desirable foamed product even when it is matured for a short time.

1. A process for preparing an expandable polystyrene (EPS) resin using a styrene monomer, a crosslinking agent, a blowing agent, polyoxyethylene sorbitan monolaurate, and a polyethylene wax synthesized from methylene oxide.

2. The process of claim 1, wherein the crosslinking agent is divinylbenzene.

3. The process of claim 1, wherein the blowing agent is a mixture of two or more selected from butane, pentane, and cyclohexane.

4. The process of claim 3, wherein the pentane is a mixture of n-pentane and isopentane in a weight ratio of 60:40 to 70:30.

5. The process of claim 1, further comprising coating the EPS resin with a coating agent selected from glycerol monostearate, glycerol tristearate, zinc stearate, hydrogenated castor oil (HCO), and a mixture thereof, wherein the coating agent is used in an amount of 2,000 to 10,000 ppm, based on 100 parts by weight of the EPS resin.

6. The process of claim 1, wherein the styrene monomer is a styrene monomer alone or a mixture of a styrene monomer as a main component and acrylonitrile or alpha-methylstyrene.

7. The process of claim 1, wherein the polyoxyethylene sorbitan monolaurate is added when a polymerization ratio reaches 70-90%.

8. An EPS resin composition comprising a Sasol-wax which is a polyethylene wax synthesized from methylene oxide.

9. The EPS resin composition of claim 8, further comprising one or more selected from the group consisting of polyoxyethylene sorbitan monolaurate, polyoxyethylene sorbitan monostearate, polyoxyethylene sorbitan monooleate, and a fatty acid ester of glycerine acetic acid.

10. The EPS resin composition of claim 8, wherein the molecular weight of the EPS resin is in the range of 250,000 to 350,000.

11. The EPS resin composition of claim 9, wherein the molecular weight of the EPS resin is in the range of 250,000 to 350,000.
